(19) United States
(12) Patent Application Publication
(10) Pub. No.: US 2006/0258287 A1
(43) Pub. Date: Nov. 16, 2006

(54) Method and a system for automatically activating and deactivating a service

(75) Inventors: Jerome Bidet, Evrecy (FR); Julien Anselme, Mondeville (FR); Eric Maschio-Esposito, Fontaine Etoupefour (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 11/406,077

(22) Filed: Apr. 18, 2006

(30) Foreign Application Priority Data
Apr. 19, 2005 (FR) 0503880

(51) Int. Cl. H04B 7/00

(52) U.S. Cl. 455/41.2

(57) ABSTRACT

A method of automatically activating and deactivating a service, comprising the following steps: a) establishing, from a first terminal, a short-range radio detection field for detecting the presence of a second terminal; b) deactivating the service if the second terminal is in the short-range radio detection field; or c) activating the service if the second terminal is not in the short-range radio detection field.

### FIELD OF THE INVENTION AND PRIOR ART

The present invention relates to services linked to forwarding electronic mail and/or telephone calls, and more particularly to services for receiving electronic mail or telephone calls on a plurality of terminals, in particular on mobile terminals.

In the case of electronic mail, there are currently different types of mail forwarding services or systems enabling a user to receive electronic mail reaching an inbox both on a computer (PC) and on a selected mobile terminal, provided that the mobile terminal is compatible with such services (e.g. a communicating personal digital assistant (PDA), SmartPhone, etc.). These services enable the user to access mail when in “roaming” mode (i.e. when moving around). Services known as “push-mail” services in which activation of mail forwarding is initiated and effected from a mail server are offered in particular by the Blackberry™ service from Research In Motion (RIM) and by the company Good Technologies™. Services known as “mobile mail synchronization” services in which activation of mail forwarding is initiated from one of the terminals by sending synchronization requests to a mail forwarding server include the Orange Bureau™ service from Orange™ and the ActiveSync™ service from Microsoft™.

These “push-mail” and “mobile mail synchronization” mail forwarding services generally offer the user functions enabling the user to activate and deactivate the service as and when required.

However, active management of the mail forwarding service (deactivation and reactivation of the service) is a relatively complex process for the user and the electronic mail software provides nothing to assist with this process. To activate or deactivate the service the user must use a dedicated application installed on the mobile terminal to contact the mail forwarding server. If this function is not provided, the user must contact the service administrator, for example by sending an e-mail, and request the administrator to perform the service on the user's behalf, which leads to latency in responding to changes of state.

In the case of forwarding telephone calls, the techniques currently used in Private Automatic Branch exchanges (PABX) and IP-based private Branch exchanges (IPBX) consist in entering a dual tone multifrequency (DTMF) code sequence on the telephone keypad (for example the sequence *99+telephone number) each time that the user leaves the office. Call redirection to the selected telephone number, usually that of a mobile telephone, is activated once the sequence has been entered. In this case, some or all new incoming calls are redirected to the mobile telephone, depending on the values of the parameters of the call forwarding rule that has been activated. On returning to the office, the user must enter a new sequence (for example the sequence *991) to cancel the conditional call forwarding service.

In all prior art services for automatically forwarding calls to another telephone the user has to enter a shorter or longer sequence of DTMF codes to activate the service. Call forwarding to a different telephone has to be activated and deactivated manually by the user. Even if they have advanced functions such as telephone computer coupling (TCC), current PABX and IPBX systems are not able to automate activation of the system, i.e. to enable activation and deactivation of programmed forwarding rules as a function of the presence or absence of the user in or from the room.

Consequently, in the case of forwarding electronic mail and in the case forwarding telephone calls, there is no solution for automating service activation and/or deactivation. Because of this, managing and optimizing the use of the service as a function of usage situations and in particular of access to the available terminals remain the responsibility of the user.

Aims and Brief Description of the Invention

The present invention seeks to remedy the above-mentioned problems and to propose a solution enabling automatic activation and deactivation of a service for forwarding electronic mail or telephone calls to a mobile terminal without user intervention and as a function of the proximity of the user to a fixed workstation.

The above aims are achieved by a method of automatically activating and deactivating a service, the method comprising the following steps:

a) establishing, from a first terminal, a short-range radio detection field for detecting the presence of a second terminal;

b) deactivating said service if the second terminal is in the short-range radio detection field; and

c) activating said service if the second terminal is not in the short-range radio detection field.

Accordingly, the method of the invention automatically suspends the service for forwarding mail or telephone calls to the second terminal, which is generally a mobile terminal, when the user equipped with the second terminal is near the first terminal (fixed workstation). Consequently, the forwarding service is interrupted whenever the user has access to the fixed workstation on which electronic mail can be managed using the usual electronic mail software, or can receive calls on a fixed telephone. This avoids electronic mail that has already been read on the fixed workstation being forwarded to the mobile terminal, which economizes on mail storage capacity in the mobile terminal and on bandwidth in the mobile communication network.

Moreover, in accordance with the invention, if the user's mobile terminal is no longer detected as being in the vicinity of the fixed workstation, which represents a situation in which the user no longer has access to the fixed workstation (i.e. the user is roaming), then the forwarding service is automatically activated so that the user continues to receive electronic mail or telephone calls on the mobile terminal.

The service may be an electronic mail forwarding service enabling a user to receive on the second terminal electronic mail sent to a mail server and intended to be forwarded to the first terminal, the first and second terminals each including electronic mail software for accessing said mail server.

In the case of a “push-mail” type mail forwarding service, in the step b), the surveillance application sends to a combination comprising the mail server and a mail forwarding server, either directly or via an application module associated with said combination, an indication of the presence of the second terminal in order to deactivate the service for forwarding electronic mail to said second terminal and, in the step c), the surveillance application sends to said combination, either directly or via an application module associated with said combination, an indication of the absence of the second terminal in order to activate the service for forwarding electronic mail to said second terminal.

In the case of a “mobile mail synchronization” type mail forwarding service, in the step b), the surveillance application, installed on the second terminal, inhibits the sending of synchronization requests from the second terminal to the mail server in order to deactivate the service for forwarding electronic mail to said second terminal and, in the step c), the surveillance application authorizes the sending of synchronization requests from the second terminal to the mail server in order to activate the service for forwarding electronic mail to said second terminal.

According to one particular aspect of the invention, in the step c), only electronic mail not processed (deleted or moved out of the user's inbox) during a session is forwarded to the second terminal. Thus mail processed by the user on the fixed workstation is not forwarded to the mobile terminal, which for the user provides continuity in mail management by avoiding any need to repeat processing already effected on the fixed workstation.

In the case of a telephone call forwarding service intended to enable a user to receive on the second terminal telephone calls sent to a telephone, in the step b), the surveillance application sends to a server an indication of the presence of the second terminal in order to deactivate the service for forwarding telephone calls to said second terminal and, in the step c), the surveillance application sends to a TCC server an indication of the absence of the second terminal in order to activate the service for forwarding telephone calls to said second terminal.

The present invention also relates to a terminal comprising means for setting up a connection with a mail server or with a TCC server, the terminal comprising short-range radio detection means for detecting the presence of a second terminal in a short-range radio detection field, means for deactivating a service if the second terminal is in the short-range radio field, and means for activating said service if the second terminal is not in the short-range radio detection field.

In accordance with the invention, and as described above, the terminal of the invention provides automatic activation and deactivation of the forwarding service in a manner that is totally transparent for the user as a function of the presence of the mobile terminal in the detection field or its absence therefrom.

In the case of a “push-mail” type mail forwarding service, the terminal (generally a fixed terminal) comprises means for sending to a combination consisting of the mail server and a mail forwarding server information indicating the presence of a second (generally mobile) terminal in order to deactivate the service for forwarding electronic mail to the second terminal and means for sending to that combination information indicating the absence of the second terminal in order to activate the service for forwarding electronic mail to the second terminal.

In the case of a telephone call forwarding service, the terminal (generally a fixed terminal) comprises means for sending to a server information indicating the presence of the second (generally mobile) terminal in order to deactivate the service for forwarding telephone calls to said second terminal and means for sending to the server information indicating the absence of the second terminal in order to activate the service for forwarding telephone calls to the second terminal.

In the case of a “mobile mail synchronization” type mail forwarding service, the terminal (here a mobile terminal) comprises means for inhibiting the sending of synchronization requests from said terminal to the mail server in order to deactivate the service for forwarding electronic mail to said terminal and means for authorizing the sending of synchronization requests from said terminal to the mail server in order to activate the service for forwarding electronic mail to the terminal.

The invention also relates to a surveillance computer program or application adapted to be executed by the above-described terminal. In the case of a “push-mail” type mail forwarding service, the program includes instructions for sending to the mail server an indication of the presence of the second terminal in order to deactivate the service for forwarding electronic mail to said second terminal when said second terminal is detected by said above-described terminal or an indication of the absence of the second terminal in order to activate the service for forwarding electronic mail to said second terminal.

In the case of a service for forwarding telephone calls, the program includes instructions for sending to a server an indication of the presence of the second terminal in order to deactivate the service for forwarding telephone calls to said second terminal or an indication of the absence of the second terminal in order to activate the service for forwarding telephone calls to said second terminal.

In the case of a “mobile mail synchronization” type mail forwarding service, the program includes instructions for inhibiting the sending of synchronization requests from said terminal to said mail server in order to deactivate the service for forwarding electronic mail to said terminal and for authorizing the sending of synchronization requests from said terminal to the messaging server in order to activate the service for forwarding electronic mail to said terminal.

This program may be stored on a storage medium.

### BRIEF DESCRIPTION OF THE DRAWINGS

Other features and advantages of the invention emerge from the following description of particular embodiments of the invention, which is given by way of non-limiting example and with reference to the appended drawings, in which:

FIG. 1 is a diagram of a first embodiment of a system of the invention;

FIG. 2 is a flowchart showing the steps of a method executed by the FIG. 1 system;

FIG. 3 is a diagram of a second embodiment of a system of the invention;

FIG. 4 is a flowchart showing the steps of a method executed by the FIG. 3 system;

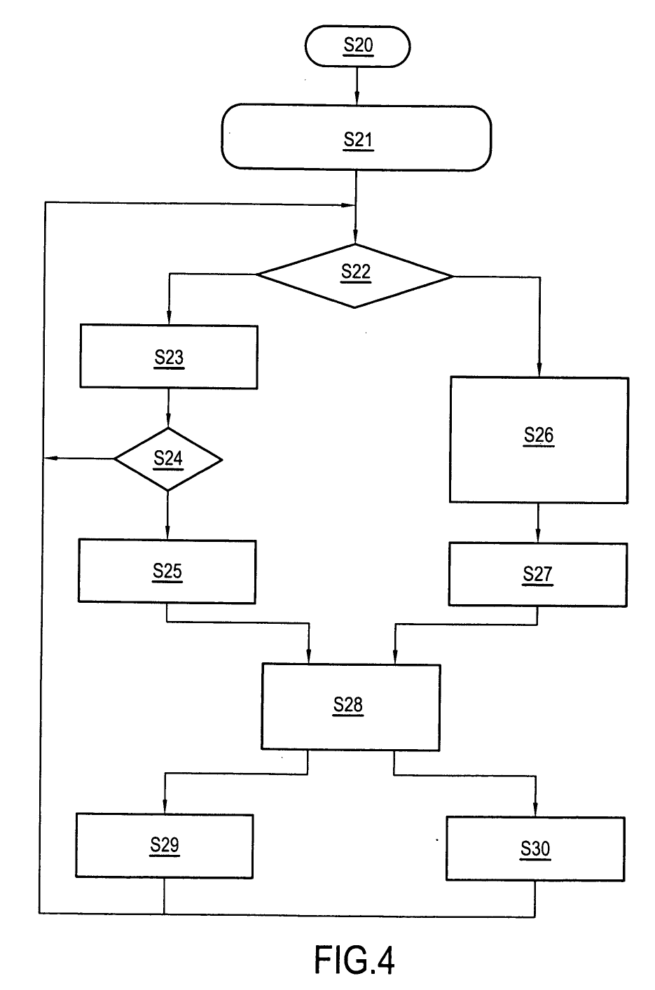

FIG. 5 is a diagram of a third embodiment of a system of the invention; and

FIG. 6 is a flowchart showing the steps of a method executed by the FIG. 5 system.

### DETAILED DESCRIPTION OF EMBODIMENTS OF THE INVENTION

The invention is intended to automate the activation and deactivation of services for forwarding electronic mail or telephone calls as a function of the proximity of a user's mobile terminal to that user's fixed workstation. To this end the invention proposes a solution that associates with this type of service the use of a short-range radio communication technology such as the Bluetooth™ or like technology. To be more precise, the invention uses the Bluetooth™ or like short-distance radio communication technology as a means of connecting the mobile terminal and detecting its presence. The Bluetooth™ short-range radio technology provides wireless connection between electronic devices. For further technical details on the Bluetooth™ technology, see in particular the following sites: http://www.bluetooth.com and http://standards.ieee.org.

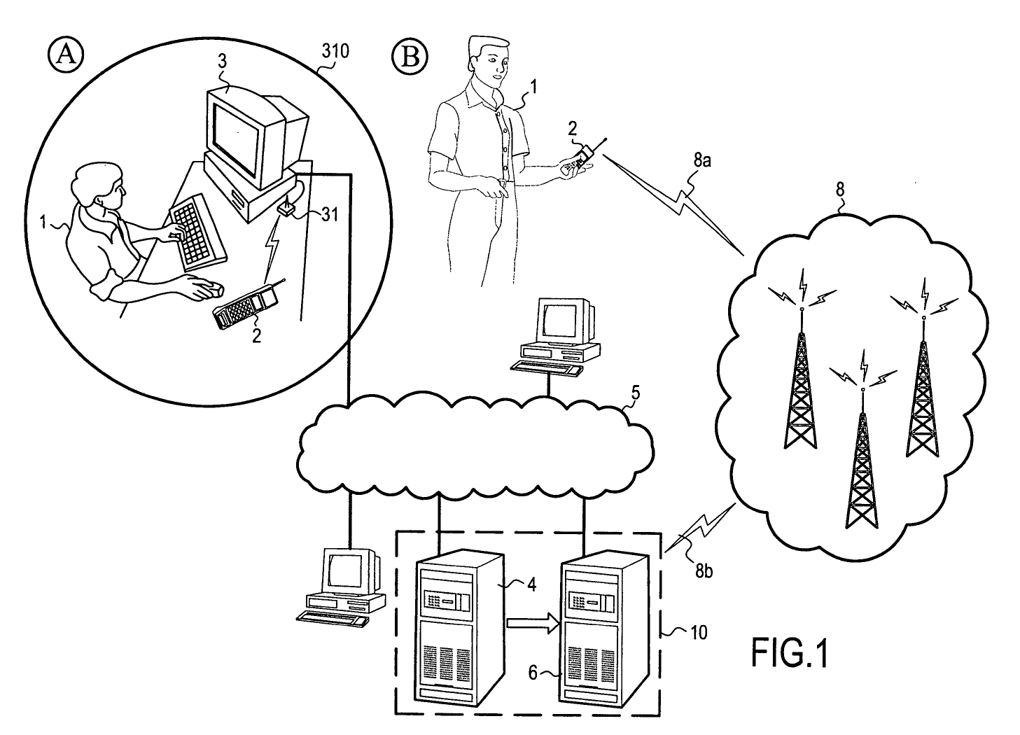

FIG. 1 is a diagram of a first embodiment of a system of the invention applied to a service for automatically activating and deactivating a “push-mail” type service. The players involved in automatically activating and deactivating a “push-mail” type service in the FIG. 1 system are a user 1 equipped with a mobile terminal 2 including short-range radio communication means such as a Bluetooth™ port (not shown) or the like and a fixed workstation 3, for example a personal computer (PC), which also includes short-range radio communication means such as a Bluetooth™ or equivalent access point 31. In the case of the present invention, the computer 3 is in detection mode, i.e. scans its short-range radio detection field continuously for the presence of a mobile terminal. In the case of the Bluetooth™ technology, for example, the computer 3 has a short-range radio detection field 310 that extends over a diameter of around 10 meters, which corresponds to the average area of an office, and confirms that, if it is detected, the user's mobile terminal is near the user's computer. To this end, in accordance with the invention, the computer 3 includes an application or software client for surveillance of short-range radio (here Bluetooth™) activity that is linked to the Bluetooth™ access point 31 and is activated automatically as soon as the access point detects the mobile terminal 2 (see below).

The presence of the mobile terminal 2 in the short-range radio detection field of the computer 3 is detected in the conventional way according to the protocols and principles defined by the type of connection that is used (e.g. Bluetooth™). The general principle is that the short-range radio access point associated with the computer 3 is in detection mode, listening out for a short-range radio signal transmitted by the mobile terminal 2. Using the Bluetooth™ technology, for example, the access point 31 transmits discovery requests in the detection field to which the Bluetooth™ port of the mobile terminal 2 responds. These requests are well known in the art and are used in particular when negotiating parameters of short-range communication between two devices (e.g. speed, security, etc.) before exchanging data proper. The Bluetooth™ access point 31 dialogs with the surveillance application of the computer 3 to inform it that a mobile terminal has been detected in the field 310. Once the Bluetooth™ connection has been set up between the mobile terminal 2 and the access point 31, the surveillance application is able to exchange information with the mobile terminal in order to authenticate it.

The FIG. 1 system further comprises a mail server 4 to which the user has access from the computer 3 via a network 5, which may be an open network like the Internet or a closed network such as a corporate Intranet, in order to send and receive electronic mail.

To provide the “push-mail” type service enabling the forwarding, or to be more precise duplication, of electronic mail to the mobile terminal 2, the system comprises a mail forwarding server 6 that is linked to the mail server 4 via the network 5 to recover messages received over the network. The mail forwarding server 6 also has access to a mobile telephone network 8 via a connection 8b for forwarding mail received by the mail server 4 to the mobile terminal 2 with the connection 8a to the network 8 in accordance with the “push-mail” type mail forwarding service principle described above.

The mail server 4 and the mail forwarding server 6 form a combination 10 in which the “push-mail” type mail forwarding service is implemented. The “push-mail” type mail forwarding service may be managed (i.e. activated and deactivated) in the combination 10 in two main ways, differing in terms of the nature of the interaction between the two servers.

In a first configuration, the mail forwarding server has an expansion module (e.g. a software element (“plugin”) providing additional functions) installed directly on the mail server and it is the expansion module that analyzes changes to the inbox and instigates the copying of mail from the inbox to the mail forwarding server. At the time of synchronization to the mobile terminal, new mail contained in the inbox or changes to mail in the inbox are pushed from the mail forwarding server to the mobile terminal. In this configuration, deactivation of the “push-mail” type mail forwarding service corresponds to suspension of copying of mail from the inbox to the mail forwarding server.

In a different internal configuration of the combination 10, the mail forwarding server interrogates the mail server (as the mail client) at regular intervals, taking the place of the user (with privileged rights). The mail forwarding server then analyzes changes to the inbox (e.g. new messages, modified messages, etc.), which are pushed to the mobile terminal. In this configuration, deactivating the “push-mail” type mail forwarding service corresponds to suspending interrogation of the mail server by the mail forwarding server.

In the remainder of the description the combination 10 is considered to be in the first configuration described above.

The “push-mail” type mail forwarding service is activated or deactivated as a function of the “roaming” or “non-roaming” mode applying to the mail client profile of the user 1 managed by the administration tool of the mail server 4. When the mail client of the user 1 has a “roaming” mode profile, the mail server 4 duplicates mail that it receives and forwards it to the mail forwarding server 6 so that it is also sent to the mobile terminal 2. On the other hand, if the mail client of the user 1 has a “non-roaming” mode profile, the “push-mail” type mail forwarding service is deactivated and forwarding of mail to the mobile terminal 2 is stopped at the level of the mail server 4, which no longer copies mail to the mail forwarding server 6.

Also, the computer 3 is equipped with an electronic mail software product or client that is well known in the art and comprises in particular an inbox enabling the user to receive and consult electronic mail (e-mail). Also, the mail software (or user agent) enables a user to access the mail service of the mail server 4 using the user's own identifier. This is known in the art.

According to the present invention, activation and deactivation of the “push-mail” type mail forwarding service are managed automatically by the surveillance application, which is different from the prior art in which activation and deactivation of the “push-mail” type mail forwarding service are effected by the user, using the mail software installed on the terminal. On each event, i.e. in the event either of detection of or of loss/absence of connection with the mobile terminal, the surveillance application informs the mail server 4 via the network 5 of the user's situation. To be more precise, if the user's mobile terminal is detected in the vicinity of the computer, the application declares to the mail server 4 that it is in “non-roaming” mode. Conversely, if the Bluetooth™ connection with the terminal is interrupted, or in the absence of this kind of connection (e.g. on booting up the computer), the surveillance application declares to the mail server that the user is in “roaming” mode. As a function of the “roaming” or “non-roaming” mode declared to the mail server 4, the server's administration tool modifies the client profile to the declared mode and activates or deactivates the “push-mail” type mail forwarding service accordingly.

Depending on how the surveillance application of the computer 3 is implemented, it can either modify the profile of the user directly in the mail server or (for aspects linked to secure access to application servers) send the information to an application plugin on the mail server that handles this updating of the profile (roaming/non-roaming mode). Implementing the present invention does not necessitate any change at the level of the mail forwarding server, because the invention uses the same function as is used for manual use of the services for activating and deactivating the “push-mail” type mail forwarding service.

The mobile terminal 2 is also equipped with an electronic mail software product or client for consulting electronic mail received at the mail server 4 via the mail forwarding server 6.

Automation of activation and deactivation of a “push-mail” type service in accordance with the invention proceeds in accordance with two situations represented in FIG. 1. A first situation A corresponds to the presence of the user 1 and the mobile terminal 2 in the Bluetooth™ detection field 310 of the computer 3. In this situation, the computer 3 can communicate with the mobile terminal 2 via a Bluetooth™ connection set up between the Bluetooth™ access point 31 of the computer 3 and the Bluetooth™ port of the mobile terminal 2. The “push-mail” type mail forwarding service is automatically deactivated as soon as the computer 3 detects the presence of the mobile terminal 2. The forwarding of electronic mail to the mobile terminal 2 is then suspended (i.e. electronic mail is not routed to the mobile terminal by the mail server), for as long as the mobile terminal 2 is detected by the Bluetooth™ access point 31 of the computer 3, which corresponds to the situation in which the user is deemed to be present at the computer 3 and to be managing electronic mail directly on it using the usual mail software (situation A).

If the mobile terminal 2 leaves the Bluetooth™ detection field 310, the user 1 finds himself in the second situation B shown in FIG. 1, i.e. a roaming situation in which the user 1 no longer has access to the computer 3. As soon as the mobile terminal 2 leaves the detection field 310, the Bluetooth™ access point 31 of the computer 3 loses contact with the Bluetooth™ port of the mobile terminal. The “push-mail” type mail forwarding service is then automatically activated and updates the inbox on the mobile terminal as a function of data from the mail server 4.

Thus only mail that has not been processed, i.e. deleted or moved out of the user's inbox, during the work session become accessible from the mobile terminal 2.

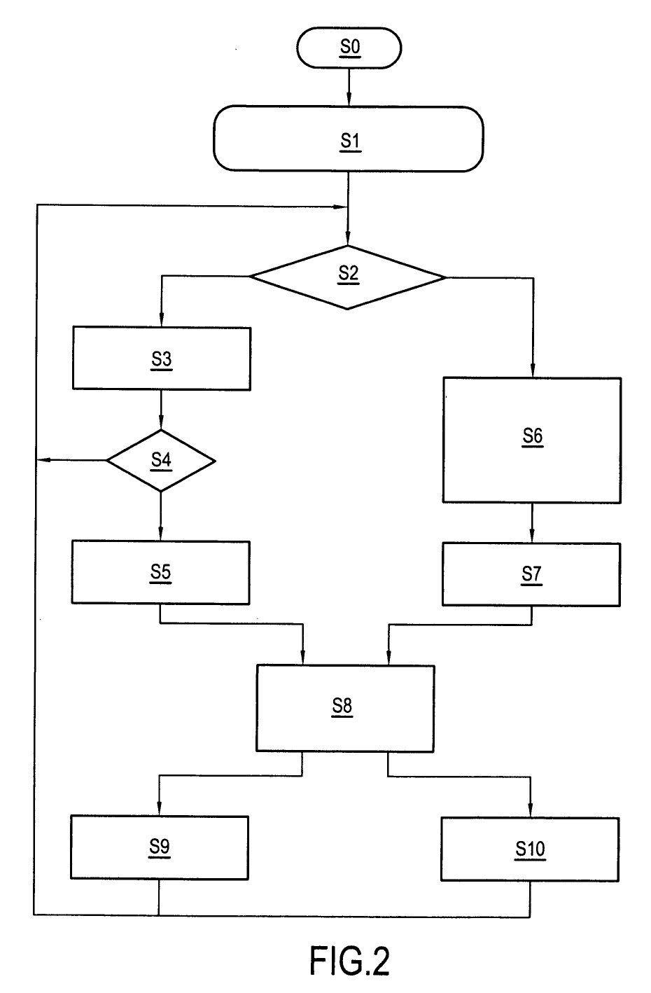

A method of automatically activating and deactivating the “push-mail” type mail forwarding service conforming to one embodiment of the invention implemented in the FIG. 1 system is described next with reference to FIG. 2.

When the computer 3 is booted up (step S0), an application or software for monitoring Bluetooth™ activity for the “push-mail” type mail forwarding service is loaded into memory (step S1). As soon as it is loaded, by dialog with the Bluetooth™ access point 31, this application scans continuously for the presence of the mobile terminal in the detection field 310 (step S2). To this end a partnership is defined beforehand between the mobile terminal 2 and the computer 3 that enables the application to recognize and authenticate the mobile terminal when it is within range of the access point 31.

For example, this kind of partnership may be defined when installing the Bluetooth™ access point 31 on the computer 3, its set-up program detecting any Bluetooth™ devices in its environment at the time. When the user's mobile terminal has been detected, the user selects it, gives it a name and carries out the procedure for exchanging a customized password between the computer and the mobile terminal. When these actions have been completed, the partnership is active; each time the terminal is detected it is recognized and the partnership is activated automatically.

If the Bluetooth™ access point 31 detects the presence of a mobile terminal (step S3), the surveillance application is advised of this and verifies if the device that has been detected conforms to the partnership defined beforehand to confirm that it is in fact the mobile terminal 2 (step S4). If the terminal that has been detected is not recognized and authenticated as being the mobile terminal 2, the application does not react and the “push-mail” type mail forwarding service remains activated.

In contrast, if the terminal that has been detected is in fact the mobile terminal 2, which in the FIG. 1 example means that the user has entered the office where the computer 3 is located (situation A), the surveillance application informs the mail server 4 via the mail client of the computer 3 that the user is in “non-roaming” mode. The administration tool of the mail server 4 then modifies the profile of the mail client and deactivates the “Push-mail” type mail forwarding service (step S5). The forwarding of mail to the mobile terminal 2 is stopped at this point.

Accordingly, if new mail reaches the mail server (step S8), it is not forwarded to the mobile terminal 2 (step S9). The above procedure is repeated for as long as the mobile terminal 2 remains in the detection field 310.

When the mobile terminal 2 leaves the Bluetooth™ detection field 310 (e.g. on loss of the connection when the user 1 of the mobile terminal 2 leaves the office (situation B in FIG. 1)) (step S6), the application informs the mail server 4 of the change of state of the user 1, who at this point reverts to the “roaming” mode. The administration tool of the mail server 4 modifies the profile of the mail client of the user 1 to the “roaming” mode and activates the “push-mail” type mail forwarding service (step S7). New electronic mail for the user received by the mail server 4 (step S8) is duplicated and forwarded to the mail forwarding server 6 so that it is also forwarded to the mobile terminal 2 (step S10). This procedure (steps S6 to S10) is equally valid whether the mobile terminal 2 is absent from or present in the detection field when the computer 3 is booted up.

Thus automating the “push-mail” type mail forwarding service in accordance with the present invention has a number of advantages. In terms of user friendliness, it avoids redundant reading and processing of electronic mail on the fixed terminal and on the mobile terminal. In terms of ergonomics, it provides automatic management of the “push-mail” type mail forwarding service, which relieves the user of activating and deactivating the service. Finally, in terms of resources, since the periods of activation of the “push-mail” type mail forwarding service on the mobile terminal are optimized, the solution of the invention optimizes network resources (e.g. bandwidth) and hardware (e.g. mobile terminal memory capacity).

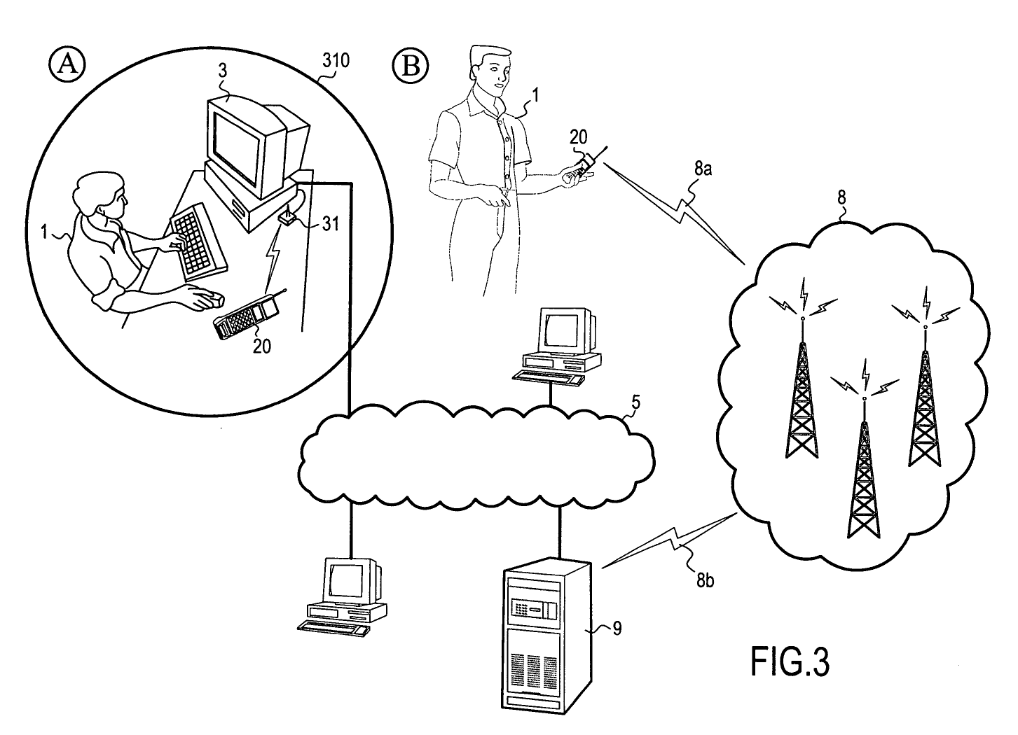

FIG. 3 is a diagram of a second embodiment of a system of the invention applied to automatically activating and deactivating a “mobile mail synchronization” mail forwarding service. The FIG. 3 system is identical to the FIG. 1 system except for the mail server 9 and for the software installed in the mobile terminal 20. For simplicity, items common to FIG. 1 are not described again.

The mail server 9 integrates the functions of a mail forwarding server for a “mobile mail synchronization” type mail forwarding service and is therefore able to receive requests from the mobile terminal 20 and to synchronize the user's inbox with the mail software of the mobile terminal over the mobile telephone network 8 via the connections 8a and 8b.

The mobile terminal 20 includes a surveillance application for inhibiting and triggering the sending of requests to the mail server supporting the synchronization service as a function of the presence of the mobile terminal in or its absence from the detection field of the computer. To this end, and differing in this respect from the FIG. 1 system, the surveillance application for detecting the presence or absence of the mobile terminal in the field 310 is installed in the mobile terminal 20, which also has short-range radio detection means such as a Bluetooth™ access point (not shown). In other words, it is now the mobile terminal 20 that is in detection mode and scans for the presence of the computer 3 to activate or deactivate the sending of synchronization requests to the mail server 9 according to whether or not the computer is in the field 310. The field 310 emitted by the access point 31 of the computer 3 here corresponds to a short-range radio “sphere” for detecting the proximity of the computer 3. The proximity of the mobile terminal 20 to the computer 3 is detected when the surveillance application in the mobile terminal is able to establish a partnership with the computer 3, i.e. when the mobile terminal 20 is in the field 310.

Using the Bluetooth™ technology, for example, the access point of the mobile terminal 20 emits discovery requests in its detection field to which the Bluetooth™ port of the computer 3 responds. Requests of this kind are well known in the art and are used in particular when negotiating parameters of short-range communication between two devices (e.g. speed, security, etc.) before exchanging data as such. The Bluetooth™ access point of the mobile terminal 20 dialogs with the surveillance application to advise it of detection of the computer 3. Once the Bluetooth™ connection has been set up between the computer 3 and the access point of the mobile terminal, the surveillance application can exchange information with the computer 3 in order to authenticate it.

A method of automatically activating and deactivating the “mobile mail synchronization” type mail forwarding service in accordance with a second embodiment of the invention implemented in the FIG. 3 system is described next with reference to FIG. 3.

When the mobile terminal 20 is booted up (step S20), software or an application for surveillance of Bluetooth™ activity for the mail forwarding service is loaded into memory in the mobile terminal (step S21). As soon as it is loaded, by dialog with the Bluetooth™ access point of the mobile terminal 20, this application scans continuously for the presence of the computer 3 in the field 310 (step S22).

If the Bluetooth™ access point of the mobile terminal 20 detects the presence of the computer 3 (step S23), the surveillance application is advised of this and verifies if the device that has been detected conforms to the partnership defined beforehand to confirm that it is in fact the computer 3 (step S24). If the terminal that has been detected is not recognized and authenticated as the computer 3, the application does not react and the “push-mail” type mail forwarding server remains activated.

On the other hand, if the terminal that has been detected is in fact the computer 3, meaning in the FIG. 3 example that the user has entered the office in which the computer 3 is located (situation A), the surveillance application inhibits the sending of synchronization requests from the mobile terminal 20 to the mail server 9 because there is no utility in that situation of duplicating mail in the mobile terminal and on the computer. The application on the mobile terminal maintains the synchronization profile of the user but nevertheless inhibits the sending of any synchronization request to the mail server 9 (step S25). From this time, new mail reaching the server 9 (step S28) is not synchronized to the mobile terminal 20 (step S29).

When the mobile terminal 20 leaves the Bluetooth™ field 310 (e.g. on loss of the connection when the user 1 of the mobile terminal 20 leaves the office (situation B in FIG. 3)) (step S26), the surveillance application authorizes the mobile terminal to resume sending programmed synchronization requests to the mail server 9 (step S27). New electronic mail for the user received by the mail server 9 (step S28) is forwarded to the mobile terminal 20 (step S30). This procedure (steps S26 to S30) is equally valid whether the mobile terminal 20 is absent from or present in the detection field when the computer 3 is booted up.

Thus automating the mail forwarding service in accordance with the invention avoids redundant reading and processing of electronic mail on the fixed workstation and on the mobile terminal and at the same time provides automatic control of the service that relieves the user of activating and deactivating the service.

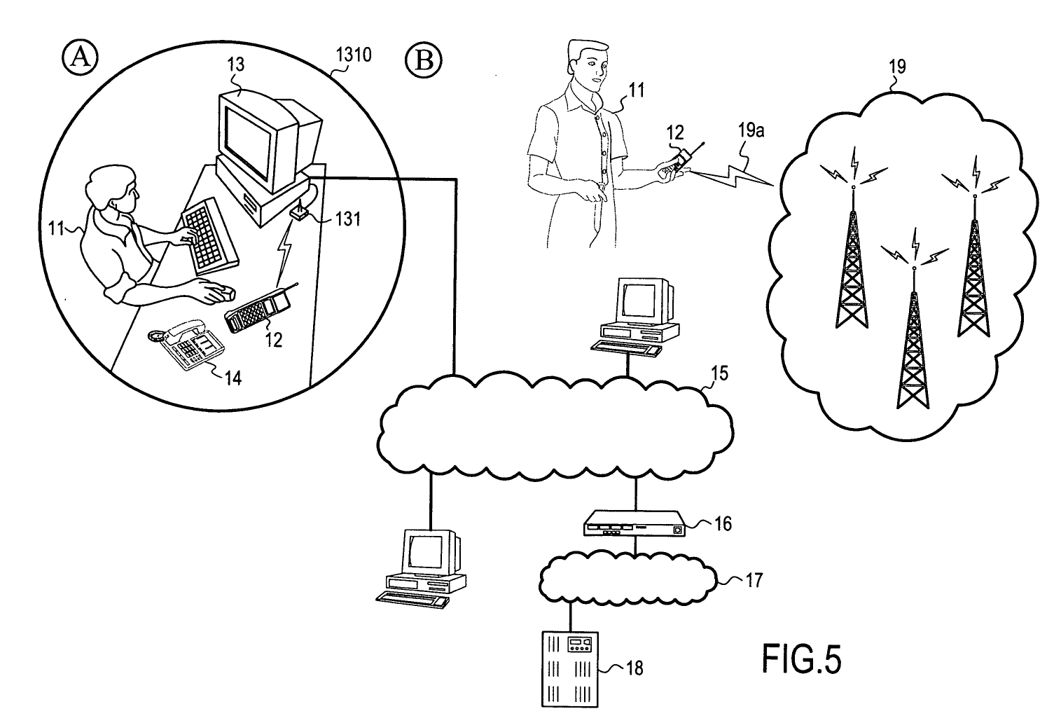

FIG. 5 is a diagram of a third embodiment of a system of the invention applied to activating and deactivating a telephone call forwarding service. The players involved in executing the method of activating and deactivating a telephone call forwarding service in the FIG. 5 system are a user 11 equipped with a mobile terminal 12 having short-range radio communication means such as a Bluetooth™ port (not shown) or the like and a fixed workstation such as a computer (PC) 13, for example, that also includes short-range radio communication means such as a Bluetooth™ access point 131 or the like. The computer 13 has a short-range radio detection field 1310 and application or client software for monitoring short-range radio activity (here Bluetooth™ activity) that is connected to the Bluetooth™ access point 131 and that is activated automatically as soon as the access point 131 detects the mobile terminal 12.

The presence of the mobile terminal 12 in the short-range radio detection field 1310 of the computer 13 is detected in the same manner as in the FIG. 1 embodiment described above.

The computer 13 is connected to a local area network 15. The mobile terminal 12 has access to a mobile telephone network 19 via a connection 19a.

The FIG. 5 system further comprises a fixed office telephone 14, a telephone exchange 18 which can be of the Private Automatic Branch exchange (PABX) type as in FIG. 5, connected to a telephone network 17, or of the Voice over IP (IP-based private Branch exchange (IPBX)) type, in which case the exchange is connected directly to the local area network 15. The system further comprises a telephone computer coupling (TCC) server 16 offering advanced parameter setting functions for the private exchange 18, for example telephone call forwarding. The operation of PABX and IPBX type exchanges offering TCC services is well known in the art and need not described in more detail.

The telephone call forwarding service is activated or deactivated as a function of the presence/absence of the mobile terminal 12 of the user in/from the detection field 1310. If the user with the mobile terminal 12 is outside the detection field 1310 (situation B), the computer 13 sends a forwarding activation service request to the TCC server 16, which generates a control sequence for activating the call forwarding rules in the exchange 18. In contrast, if the user with the mobile terminal 12 is in the detection field 1310 (situation A), the computer 13 sends a request for deactivation of the forwarding service to the TCC server 16, which generates a control sequence for deactivating the call forwarding rules in the exchange 18.

The computer 3 is further equipped with TCC client software to enable the user to define call forwarding rules. In the example considered here, the user 11 defines a rule to the effect that incoming calls reaching the fixed telephone 14 are to be forwarded to the mobile terminal 12 if the mobile terminal is outside the detection field 1310.

According to the present invention, activation and deactivation of the call forwarding service are managed automatically by the surveillance application, which is different from the prior art, in which the user activates and deactivates this kind of service from the telephone.

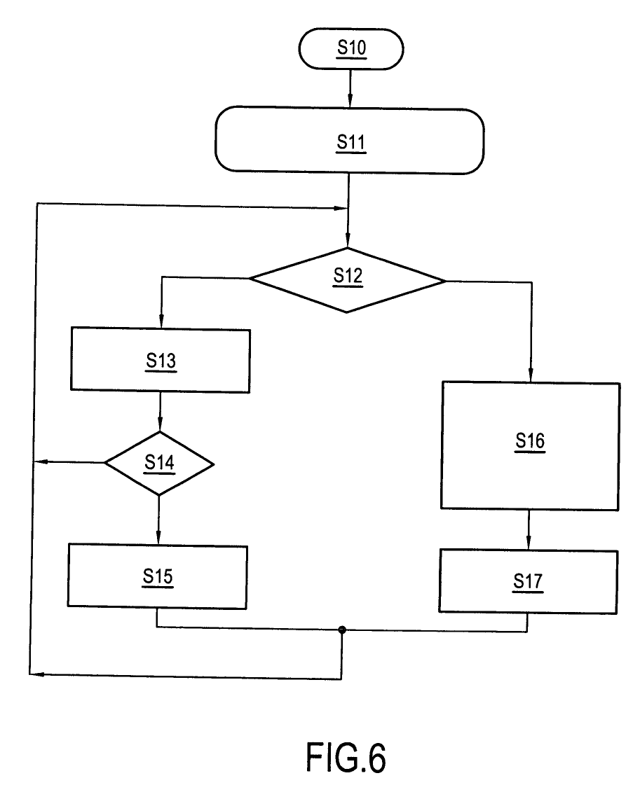

A method of automatically activating and deactivating the call forwarding service in accordance with an embodiment of the invention used in the FIG. 5 system is described next with reference to FIG. 6.

When the computer 3 is booted up (step S10), an application or software for surveillance of Bluetooth™ activity for the telephone call forwarding service is loaded into memory (step S11). As soon as it is loaded, this application, by dialog with the Bluetooth™ access point 131, scans continuously for the presence of the mobile terminal 12 in the detection field 1310 (step S12). To this end, a partnership between the mobile terminal 12 and the computer 13 is defined beforehand that enables the application to recognize and authenticate the mobile terminal when the terminal is within range of the access point 131 (for example the partnership defined when installing the Bluetooth™ access point 31 as described with reference to FIG. 1).

If the Bluetooth™ access point 31 detects a mobile terminal (step S13), the application is advised of this and verifies if the device that has been detected conforms to the predefined partnership to determine if it is in fact the mobile terminal 12 (step S14). If the terminal that has been detected is not recognized and authenticated as the mobile terminal 12, the application does not react and the call forwarding service remains activated.

In contrast, if the terminal that has been detected does in fact correspond to the mobile terminal 12, which in the FIG. 5 example means that the user has entered the office in which the computer 13 is located (situation A), the application sends a request for deactivation of the forwarding rules for the user 11 to the TCC server 16, which generates a control sequence for deactivating the rules for forwarding calls to the exchange 18 (step S15). The TCC server launches a DTMF code sequence to cancel the forwarding initiated at the telephone exchange which may, like the exchange 18, be a PABX or an IPBX (depending on whether the business has a standard PABX or uses the Telephone over IP (TOIP) mode). From this time onwards, incoming calls are received on the telephone 14.

If the mobile terminal 12 leaves the Bluetooth™ detection field 1310 (e.g. on loss of connection if the user 1 of the mobile terminal 2 leaves the office (situation B in FIG. 5)) (step S17), the application sends a request for activation of the forwarding rules defined for the user 11 to the TCC server 16, which generates a control sequence for activating the call forwarding rules in the exchange 18 (step S17). The TCC server launches a DTMF code sequence to activate the forwarding initiated in the PABX or IPBX (depending on whether the business has a standard PABX or uses the Telephone over IP (TOIP) mode). From this time, incoming calls reaching the telephone 14 are forwarded to the mobile terminal 12.

Thus the present invention offers the user simple use of the telephone call forwarding service by passive implementation of the service (i.e. transparently from the user's point of view). It also allows the contactability of the user within a business to be optimized, the call routing rules adapting automatically and in real time as a function of the movements of the user.

What is claimed is:

1. A method of automatically activating and deactivating a service, the method comprising the following steps:
a) establishing, from a first terminal, a short-range radio detection field for detecting the presence of a second terminal;
b) deactivating said service if the second terminal is in the short-range radio detection field; and
c) activating said service if the second terminal is not in the short-range radio detection field.

2. A method according to claim 1, wherein the service is an electronic mail forwarding service enabling a user to receive on the second terminal electronic mail sent to a mail server and intended to be forwarded to the first terminal, the first and second terminals each including electronic mail software for accessing said mail server.

3. A method according to claim 1, wherein, in the step a), an application for surveillance of the short-range radio activity is executed on the first terminal as soon as it is started up.

4. A method according to claim 3, wherein, in the step b), the surveillance application sends to a combination comprising the mail server and a mail forwarding server, either directly or via an application module associated with said combination, an indication of the presence of the second terminal in order to deactivate the service for forwarding electronic mail to said second terminal and, in the step c), the surveillance application sends to said combination, either directly or via an application module associated with said combination, an indication of the absence of the second terminal in order to activate the service for forwarding electronic mail to said second terminal.

5. A method according to claim 1, wherein, in the step a), an application for surveillance of short-range radio activity is executed on the second terminal as soon as it is started up.

6. A method according to claim 5, wherein, in the step b), the surveillance application inhibits the sending of synchronization requests from the second terminal to the mail server in order to deactivate the service for forwarding electronic mail to said second terminal and, in the step c), the surveillance application authorizes the sending of synchronization requests from the second terminal to the mail server in order to activate the service for forwarding electronic mail to said second terminal.

7. A method according to claim 2, wherein, in the step c), only electronic mail not processed by the user on the first terminal is forwarded to the second terminal.

8. A method according to claim 1, wherein the service is a telephone call forwarding service enabling a user to receive on the second terminal telephone calls sent to a telephone.

9. A method according to claim 8, wherein, in the step b), the surveillance application sends to a server an indication of the presence of the second terminal in order to deactivate the service for forwarding telephone calls to said second terminal and, in the step c), the surveillance application sends to the server an indication of the absence of the second terminal in order to activate the service for forwarding telephone calls to said second terminal.

10. A terminal comprising means for setting up a connection with a mail server or with a server, the terminal comprising short-range radio detection means for detecting the presence of a second terminal in a short-range radio detection field, means for deactivating a service if the second terminal is in the short-range radio field, and means for activating said service if the second terminal is not in the short-range radio detection field.

11. A terminal according to claim 10, wherein the service is an electronic mail forwarding service enabling a user to receive on the second terminal electronic mail sent to a mail server and intended to be forwarded to said terminal and said terminal includes means for sending to a combination comprising the mail server and a mail forwarding server an indication of the presence of the second terminal in order to deactivate the service for forwarding electronic mail to said second terminal and means for sending to said combination an indication of the absence of the second terminal in order to activate the service for forwarding electronic mail to said second terminal.

12. A terminal according to claim 10, wherein the service is a telephone call forwarding service enabling a user to receive on the second terminal telephone calls sent to a telephone and said terminal includes means for sending to a server an indication of the presence of the second terminal in order to deactivate the service for forwarding telephone calls to said second terminal and means for sending to a server an indication of the absence of the second terminal in order to activate the service for forwarding telephone calls to said second terminal.

13. A terminal according to claim 10, wherein the service is an electronic mail forwarding service enabling a user to receive on said terminal electronic mail sent to a mail server and intended to be forwarded to the second terminal and said terminal comprises means for inhibiting the sending of synchronization requests from said terminal to the mail server in order to deactivate the service for forwarding electronic mail to said terminal and means for authorizing the sending of synchronization requests from said terminal to the mail server in order to activate the service for forwarding electronic mail to said terminal.

14. A computer program adapted to be executed by a terminal according to claim 11, the computer program including instructions for sending to the mail server an indication of the presence of the second terminal in order to deactivate the service for forwarding electronic mail to said second terminal when the second terminal is detected by said terminal or an indication of the absence of the second terminal in order to activate the service for forwarding electronic mail to said second terminal.

15. A computer program adapted to be executed by a terminal according to claim 12, the computer program including instructions for sending to a server an indication of the presence of the second terminal in order to deactivate the service for forwarding telephone calls to said second terminal or an indication of the absence of the second terminal in order to activate the service for forwarding telephone calls to said second terminal.

16. A computer program adapted to be executed by a terminal according to claim 13, the computer program including instructions for inhibiting the sending of synchronization requests from said terminal to said mail server in order to deactivate the service for forwarding electronic mail to said terminal and for authorizing the sending of synchronization requests from said terminal to the messaging server in order to activate the service for forwarding electronic mail to said terminal.

17. A storage medium on which a program according to claim 14 is stored.
